(19) United States
(12) Patent Application Publication
(10) Pub. No.: US 2025/0273717 A1
(43) Pub. Date: Aug. 28, 2025

(54) FUEL CELL SYSTEM AND CONTROL METHOD THEREOF

(71) Applicant: HONDA MOTOR CO., LTD., Tokyo (JP)

(72) Inventor: Takuma SONOBE, Saitama (JP)

(21) Appl. No.: 19/040,907

(22) Filed: Jan. 30, 2025

(30) Foreign Application Priority Data
Feb. 22, 2024 (JP) 2024-025741

(51) Int. Cl. H01M 8/04858; H01M 8/0438

(52) U.S. Cl. CPC H01M 8/0488; H01M 8/04395

(57) ABSTRACT

A fuel cell system (FC system) includes a fuel cell stack (FC stack) that generates power by reaction between fuel gas and oxidant gas, an oxidant gas supply device that supplies the oxidant gas to the fuel cell stack, an oxygen concentration acquisition unit that acquires an oxygen concentration in the fuel cell stack, and a voltage control unit that controls a voltage of the fuel cell stack, in which the voltage control unit changes a reduction rate of the voltage of the fuel cell stack according to the oxygen concentration when the fuel cell system is to be stopped.

### BACKGROUND

### Technical Field

The present invention relates to a fuel cell system capable of efficiently reducing a voltage when an operation of a fuel cell is to be stopped, and a control method thereof.

### Related Art

In recent years, research and development on fuel cells that contribute to energy efficiency has been conducted in order for more people to be able to access affordable, reliable, sustainable, and advanced energy.

In a fuel cell system that generates power using a fuel cell, there is a problem that an electrode and an electrolyte membrane are deteriorated by residual oxygen in a cathode system when an operation of the fuel cell is to be stopped. As a solution to such a problem, a technique has been developed to suppress deterioration of a fuel cell by supplying an appropriate amount of fuel gas, such as hydrogen, to the anode when the fuel cell is to be stopped and causing it to react with the residual oxygen in the cathode to consume the residual oxygen.

For example, JP 2020-087529 A discloses a technique of determining whether oxygen in a cathode is normally consumed based on a voltage value of a fuel cell stack while a fuel cell system is stopped, and supplying a sufficient amount of fuel gas to consume the residual oxygen in the cathode by changing a pressure of the fuel gas supplied to the anode based on the determination result.

### CITATION LIST

### Patent Literature

Patent Literature 1: JP 2020-087529 A

### SUMMARY

Conventionally, when an operation of a fuel cell is to be stopped, it has been controlled to reduce a voltage of a fuel cell stack at a constant reduction rate according to a voltage command value from a control unit.

Here, when the voltage of a fuel cell stack is to be reduced, there is a demand to reduce the voltage of the fuel cell stack as quickly as possible from the viewpoint of suppressing deterioration of the fuel cell stack.

Meanwhile, due to the I-V characteristic and the I-P characteristic of a general fuel cell, the current increases when the voltage of a fuel cell stack decreases, and the output (generated power amount) increases when the current increases. For example, in a case of a system that stores power generated by a fuel cell in a battery, there is an upper limit of power that can be supplied to the battery due to the charging characteristics of the battery. Therefore, it is necessary to control the output of the fuel cell stack to a certain value or less, and this can make it difficult to rapidly reduce the voltage of the fuel cell stack.

Thus, when the voltage of a fuel cell stack is to be reduced, there are two conflicting demands as described above. Conventionally, it has been difficult to satisfy both of these demands, and instead of satisfying one demand, the reduction rate of a voltage command value has been set in such a manner as to compromise the other demand.

That is, in a case where the focus is on suppressing deterioration of a fuel cell stack, the voltage has been reduced rapidly by setting the voltage reduction rate high, knowing that there is a possibility that the voltage will exceed the upper limit of power that can be supplied to the battery. On the other hand, in a case where the focus is on the upper limit of power that can be supplied to the battery, the voltage has been gradually reduced by setting the voltage reduction rate low, knowing that deterioration of the fuel cell stack will progress.

For this reason, there has been a demand for a fuel cell system capable of suppressing deterioration of a fuel cell stack while controlling an output of a fuel cell to be equal to or less than an upper limit of power that can be supplied to a battery when an operation of the fuel cell is to be stopped.

The present invention has been made to solve such a problem, and a purpose of the present invention is to provide a fuel cell system capable of suppressing deterioration of a fuel cell stack while controlling an output of a fuel cell to a certain value or less when an operation of the fuel cell is to be stopped. This ultimately contributes to energy efficiency.

In order to achieve this purpose, a fuel cell system (FC system 1) according to claim 1 of the present invention includes a fuel cell stack (FC stack 2) that generates power by reaction between fuel gas and oxidant gas, an oxidant gas supply device 3 that supplies the oxidant gas to the fuel cell stack, an oxygen concentration acquisition unit 51 that acquires an oxygen concentration in the fuel cell stack, and a voltage control unit 52 that controls a voltage of the fuel cell stack, wherein the voltage control unit 52 changes a reduction rate of the voltage of the fuel cell stack according to the oxygen concentration when the fuel cell system is to be stopped.

In this fuel cell system, the oxygen concentration in the fuel cell stack is acquired by the oxygen concentration acquisition unit, and the voltage control unit changes the voltage reduction rate of the fuel cell stack when the fuel cell system is to be stopped according to the acquired oxygen concentration.

In the present invention, the oxygen concentration in the fuel cell stack after the stop of the fuel cell system is used as an index indicating a generated power amount after a start of a process to stop the fuel cell system. For example, when the oxygen concentration in the fuel cell stack is high, it is determined that the generated power amount in the fuel cell stack is large and the output of the fuel cell stack is likely to be excessive. On the other hand, when the oxygen concentration in the fuel cell stack is low, it is determined that the generated power amount in the fuel cell stack is small and the risk of the output of the fuel cell stack being excessive is small.

Then, by changing the voltage reduction rate according to the oxygen concentration, instead of using a constant (fixed) voltage reduction rate as in the conventional case, different voltage reduction rates can be used according to the state of power generation of the fuel cell stack.

That is, by changing the voltage reduction rate according to the oxygen concentration in the fuel cell stack, the voltage reduction rate according to the generated power amount in the fuel cell stack can be set. As a result, for example, it is possible to set the voltage reduction rate low in order to suppress an increase in output when the oxygen concentration is high, and to set the voltage reduction rate high in order to suppress deterioration of the fuel cell stack by quickly reducing the voltage when the oxygen concentration is low.

In this manner, by changing the reduction rate of the voltage of the fuel cell stack according to the oxygen concentration when an operation of the fuel cell system is to be stopped, it is possible to control the output of the fuel cell to a certain value or less while suppressing deterioration of the fuel cell stack.

An invention according to claim 2 of the present invention is the fuel cell system according to claim 1 further including a flow rate acquisition unit (flow rate sensor 37 and control device 5) that acquires a flow rate of the oxidant gas supplied to the fuel cell stack as an oxidant gas flow rate, and a current value acquisition unit (current sensor 25) that acquires a current value of the fuel cell stack, wherein the oxygen concentration acquisition unit estimates and acquires the oxygen concentration based on the oxidant gas flow rate and the current value.

According to this configuration, the oxygen concentration acquisition unit estimates the oxygen concentration based on the flow rate of the oxidant gas supplied to the fuel cell stack and the current value of the fuel cell stack.

That is, in this configuration, the oxidant gas flow rate is used as an index indicating the amount of oxidant gas supplied into the fuel cell stack, and the current value of the fuel cell stack is used as an index indicating the amount of oxidant gas consumed in the fuel cell stack. Since the oxygen concentration is estimated based on the oxidant gas flow rate and the current value, the concentration of residual oxygen in the fuel cell stack can be estimated with high accuracy.

An invention according to claim 3 of the present invention is the fuel cell system according to claim 1 or 2, wherein the voltage control unit reduces the reduction rate of the voltage as the oxygen concentration is higher when the fuel cell system is to be stopped.

According to this configuration, the voltage control unit performs a control in such a manner that the reduction rate of the voltage of the fuel cell stack is to be low as the oxygen concentration in the fuel cell stack is higher when the fuel cell system is to be stopped. Therefore, it is possible to set the reduction rate of the voltage low in a case where the output is likely to be excessive when there is a large amount of residual oxygen in the fuel cell stack, such as immediately after the start of a process to stop the fuel cell system, and the generated power amount of the fuel cell stack is large. As a result, it is possible to prevent the voltage of the fuel cell stack from greatly decreasing to more reliably control the output of the fuel cell stack to a certain value or less.

An invention according to claim 4 of the present invention is the fuel cell system according to claim 1 or 2, wherein the voltage control unit increases the reduction rate of the voltage as the oxygen concentration is lower when the fuel cell system is to be stopped.

According to this configuration, the voltage control unit performs a control in such a manner that the reduction rate of the voltage of the fuel cell stack is to be high as the oxygen concentration in the fuel cell stack is lower when the fuel cell system is to be stopped. Therefore, it is possible to set the reduction rate of the voltage high in a case where the oxygen concentration is reduced by oxygen in the fuel cell stack being consumed by reaction with fuel gas when a certain time elapses after the start of a process to stop the fuel cell system. As a result, it is possible to quickly reduce the voltage of the fuel cell stack in a case where there is no risk of the output being excessive to more effectively suppress deterioration of the fuel cell stack.

A control method of the fuel cell system according to claim 5 of the present invention is a control method of a fuel cell system including a fuel cell stack that generates power by reaction between fuel gas and oxidant gas, an oxidant gas supply unit that supplies the oxidant gas to the fuel cell stack, an oxygen concentration acquisition unit that acquires an oxygen concentration in the fuel cell stack, and a voltage control unit that controls a voltage of the fuel cell stack, wherein the voltage control unit performs a control to change a reduction rate of the voltage of the fuel cell stack according to the oxygen concentration when the fuel cell system is to be stopped.

In the control method of the fuel cell system of the present invention, by changing the voltage reduction rate according to the oxygen concentration in the fuel cell stack, the voltage reduction rate according to the generated power amount in the fuel cell stack can be set. As a result, for example, it is possible to set the voltage reduction rate low in order to suppress an increase in output when the oxygen concentration is high, and to set the voltage reduction rate high in order to suppress deterioration of the fuel cell stack when the oxygen concentration is low.

In this manner, by changing the reduction rate of the voltage of the fuel cell stack according to the oxygen concentration when an operation of the fuel cell system is to be stopped, it is possible to control the output of the fuel cell to a certain value or less while suppressing deterioration of the fuel cell stack.

### BRIEF DESCRIPTION OF DRAWINGS

FIG. 1 is a schematic configuration diagram of a fuel cell vehicle on which a fuel cell system according to an embodiment of the present invention is mounted;

FIG. 2 is a configuration diagram showing a configuration of a control system of the fuel cell system according to the embodiment;

FIG. 3 is a diagram showing a relationship between an oxidant gas flow rate and an oxygen concentration in a fuel cell stack;

FIG. 4 is a diagram showing a relationship between a current value and an oxygen concentration in the fuel cell stack;

FIG. 5 is a flowchart showing a voltage control process when the fuel cell system according to the embodiment is to be stopped; and

FIG. 6 is a diagram showing a relationship between an oxygen concentration and a voltage reduction rate in the voltage control according to the embodiment in comparison with a conventional example.

### DETAILED DESCRIPTION

Hereinafter, preferred embodiments of a fuel cell system of the present invention will be described in detail with reference to the drawings. A fuel cell system described as an example according to an embodiment is mounted on a fuel cell vehicle and functions as one of power sources of the fuel cell vehicle. The fuel cell vehicle may be a two-wheeled vehicle, a three-wheeled vehicle, a four-wheeled vehicle, or the like. Note that the configuration described below is an example of the present invention, and the present invention is not limited thereto. For example, the fuel cell system of the present invention may be mounted on a moving body such as a ship or an airplane, in addition to a vehicle, or may be used in a stationary facility such as a house or a building.

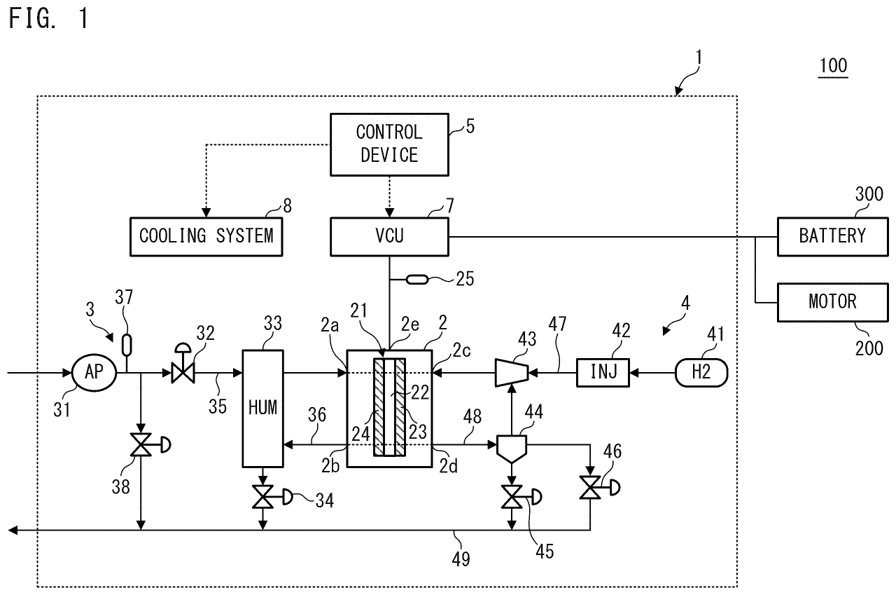

FIG. 1 is a schematic configuration diagram of a fuel cell vehicle 100 on which a fuel cell (FC) system 1 according to an embodiment is mounted. The fuel cell vehicle 100 is, for example, a fuel cell electric vehicle, and includes an FC system 1, a battery 300, a motor 200, and the like as shown in the diagram. Other constituent elements of the fuel cell vehicle 100 are omitted in the diagram.

The motor 200 is, for example, a three-phase alternating-current motor, and is driven using power supplied from the FC system 1 or the battery 300 as a power source. A rotor of the motor 200 is connected to driving wheels (not shown), and the motor 200 outputs driving force to be used for traveling of the fuel cell vehicle 100 to the driving wheels under the control of a high-order controller (not shown) mounted on the fuel cell vehicle 100. In addition, the motor 200 generates regenerative power using the kinetic energy of the vehicle when the vehicle decelerates.

The battery 300 is, for example, a secondary battery such as a lithium ion battery. The battery 300 stores power generated by the FC system 1 or the motor 200, and supplies power for traveling of the fuel cell vehicle 100 to the motor 200 under the control of a high-order controller.

The battery 300 is provided with sensors such as a current sensor, a voltage sensor, and a temperature sensor (not shown), and outputs a current value, a voltage value, a temperature, and the like detected by these sensors to a high-order controller.

### <Configuration of FC System 1>

Hereinafter, a specific configuration of the FC system 1 will be described. Note that the configuration described below is merely an example, and any configuration may be used as long as the system is configured to generate power using an anode and a cathode.

The FC system 1 includes a fuel cell (FC) stack 2, an oxidant gas supply device 3, a hydrogen gas supply device 4, a control device 5, a voltage control unit (VCU) 7, and a cooling system 8.

The FC stack 2 is a structure in which a plurality of power generation cells 21 is stacked. The FC stack 2 is provided with an oxidant gas inlet 2a, an oxidant gas outlet 2b, a hydrogen gas inlet 2c, a hydrogen gas outlet 2d, and an electrode 2e.

Each power generation cell 21 is a battery that generates power by an electrochemical reaction between fuel gas supplied to the anode and oxidant gas supplied to the cathode. In the present embodiment, hydrogen gas is used as the fuel gas, and air containing oxygen is used as the oxidant gas.

Each power generation cell 21 has a configuration in which a solid polymer electrolyte membrane (hereinafter, also simply referred to as an electrolyte membrane) 22 made of, for example, a cation exchange membrane, such as a thin film of perfluorosulfonic acid containing moisture, is sandwiched between an anode electrode 23 and a cathode electrode 24. As the electrolyte membrane 22, in addition to a fluorine-based electrolyte, a hydrocarbon-based electrolyte or the like can be used.

To the anode electrode 23, hydrogen gas which is fuel gas containing hydrogen is supplied from the hydrogen gas supply device 4. To the cathode electrode 24, air which is oxidant gas containing oxygen is supplied from the oxidant gas supply device 3. The hydrogen supplied to the anode electrode 23 is ionized by a catalytic reaction on an anode catalyst (not shown), and the generated hydrogen ions pass through the electrolyte membrane 22 and move to the cathode electrode 24. The electrons emitted with the ionization of hydrogen move through the electrode 2e to an external circuit to generate a current, thereby generating power. The hydrogen ions moved from the anode electrode 23 to the cathode electrode 24 react with the oxygen supplied to the cathode electrode 24 to generate water.

The oxidant gas supply device 3 includes an air pump 31 that compresses air from atmosphere and supplies the air to the FC stack 2, and the air pump 31 is disposed in an air supply flow path 35. The air pump 31 is driven and controlled by the control device 5.

The air supply flow path 35 is provided with a humidifier 33. The air supply flow path 35 communicates with the oxidant gas inlet 2a of the FC stack 2.

In addition, a flow rate sensor 37 that detects an air flow rate at the outlet of the air pump 31 is disposed in the air supply flow path 35. Information on the air flow rate detected by the flow rate sensor 37 is transmitted to the control device 5.

In addition, the air supply flow path 35 is connected to a purge flow path 49, which will be described later, via a bypass valve 38.

The oxidant gas outlet 2b communicates with an air discharge flow path 36 passing through the humidifier 33. The humidifier 33 recovers moisture from air after the reaction (including gas after the reaction and off gas) discharged from the oxidant gas outlet 2b and passing through the air discharge flow path 36, and humidifies air passing through the air supply flow path 35 using the moisture. As a result, the electrolyte membrane 22 in each power generation cell 21 of the FC stack 2 can be maintained at a humidity suitable for power generation.

On the downstream side of the air pump 31 in the air supply flow path 35, a supply-side sealing valve 32 is provided. The supply-side sealing valve 32 is opened and closed under the control of the control device 5 to switch between opening and closing of the air supply flow path 35.

In addition, a discharge-side sealing valve 34 is provided in the air discharge flow path 36. The discharge-side sealing valve 34 is opened and closed under the control of the control device 5 to switch between opening and closing of the air discharge flow path 36. The downstream side of the discharge-side sealing valve 34 is connected to the purge flow path 49, which will be described later.

The hydrogen gas supply device 4 includes a hydrogen tank 41 that stores high-pressure hydrogen gas. The hydrogen tank 41 communicates with the hydrogen gas inlet 2c of the FC stack 2 via a hydrogen supply flow path 47. In the hydrogen supply flow path 47, an injector 42 and an ejector 43 are provided in series.

The injector 42 specifies a supply amount and a supply timing of hydrogen gas supplied to the FC stack 2 by an opening degree of the injector 42 being controlled by the control device 5. Due to a negative pressure inside the ejector 43, the ejector 43 sucks off gas discharged from the hydrogen gas outlet 2d to an off-gas flow path 48 and recirculates the off gas to the hydrogen supply flow path 47.

The off-gas flow path 48 communicates with the hydrogen gas outlet 2d of the FC stack 2, and a gas-liquid separator 44 is connected to the off-gas flow path 48.

The gas-liquid separator 44 separates the off gas discharged from the hydrogen gas outlet 2d of the FC stack 2 into gas components and liquid components. The liquid components separated from the off gas are discharged to the purge flow path 49 via a drain valve 45 which is opened and closed by the control device 5. In addition, a part of the gas components separated from the off gas is recirculated via the ejector 43, and the other part of the gas components is discharged to the purge flow path 49 via a purge valve 46 which is opened and closed by the control device 5.

The purge flow path 49 is a flow path communicating with the outside of the fuel cell vehicle 100. The off gas containing hydrogen flowing through the purge flow path 49 is mixed with the air after the reaction (including gas after the reaction and off gas) discharged from the oxidant gas outlet 2b and the air bypassed from the air supply flow path 35 via the bypass valve 38, diluted, and then discharged to the outside.

The VCU 7 is, for example, a boost type DC-DC converter. The VCU 7 is disposed between the anode electrode 23 and the cathode electrode 24 of the FC stack 2 and an electrical load outside the FC system 1.

The VCU 7 has a function of changing the output state of the FC stack 2 under the control of the control device 5. Specifically, the VCU 7 has a function of setting an output voltage when the FC stack 2 generates power. In addition, the VCU 7 has a function of boosting the output voltage to a desired voltage when power generated by the FC stack 2 is supplied to a load, such as the motor 200, the battery 300, the air pump 31, or other various auxiliary machines.

Between the VCU 7 and the FC stack 2, a current sensor 25 is disposed. The current sensor 25 detects the generated current of the FC stack 2, and transmits the detected value to the control device 5.

The control device 5 is an ECU constituted by a microcomputer including a CPU, a RAM, a ROM, an I/O interface (none of which is shown), and the like.

The control device 5 is configured to be able to acquire information on the state of the FC system 1 based on detection values of various sensors (not shown). The acquired state of the FC system includes, for example, a power generation state, a generated power amount, a power generation time, the number of starts (or the number of stops) and the like at present.

In addition, the control device 5 performs a control such as opening and closing control of various valves, drive control of various auxiliary machines (the air pump 31 and the like) in the FC system 1 and generated power amount control of the FC stack 2 via the VCU 7. In addition, the control device 5 controls a supply amount and a supply timing of hydrogen gas supplied to the FC stack 2 by controlling an opening degree of the injector 42 while referring to a value of a pressure sensor (not shown) disposed in the anode electrode 23. Furthermore, the control device 5 operates the cooling system 8 to control the temperature adjustment of the FC stack 2.

Note that the control device 5 may perform charge and discharge control of the battery 300 and power running and regenerative drive control of the motor 200.

As described above, the control device 5 is connected to the flow rate sensor 37 and the current sensor 25, and the detection signals thereof are successively input. The control device 5 loads and executes a program stored in the ROM or the RAM based on the inputs from these sensors, thereby implementing the functions of an oxygen concentration acquisition unit 51 and a voltage control unit 52, which will be described later.

The cooling system 8 cools the FC stack 2 under the control of the control device 5. For example, the cooling system 8 cools the FC stack 2 by circulating a refrigerant, such as pure water or ethylene glycol, in a refrigerant flow path (not shown) provided in the FC stack 2.

### <Power Generation Operation of FC System 1>

A power generation operation of the FC system 1 (a power generation operation in the FC stack 2) configured as described above will be described below.

The oxidant gas supply device 3 supplies air as the oxidant gas to the air supply flow path 35 via the air pump 31. This air is humidified through the humidifier 33 and then supplied from the oxidant gas inlet 2a to the FC stack 2.

On the other hand, the hydrogen gas supply device 4 supplies hydrogen gas from the hydrogen tank 41 to the hydrogen supply flow path 47 under the control of the control device 5 for the opening degree of the injector 42. This hydrogen gas passes through the ejector 43 and is then supplied from the hydrogen gas inlet 2c to the FC stack 2.

The air supplied from the oxidant gas inlet 2a to the FC stack 2 is supplied to the cathode electrode 24 of each power generation cell 21, and the hydrogen gas supplied from the hydrogen gas inlet 2c to the FC stack 2 is supplied to the anode electrode 23 of each power generation cell 21. As a result, in each power generation cell 21, hydrogen and oxygen in the air are consumed by an electrochemical reaction, and power generation is performed.

The power generated by the power generation is supplied to the motor 200, the battery 300, various other auxiliary machines, and the like via the VCU 7 under the control of the control device 5.

The air after the reaction (including gas after the reaction and off gas) in the cathode electrode 24 of each power generation cell 21 is discharged from the oxidant gas outlet 2b to the air discharge flow path 36. Moisture of the discharged air is recovered when the air passes through the humidifier 33, and then the resulting air is discharged to the outside through the purge flow path 49. As described above, the moisture recovered by the humidifier 33 is used to humidify the air passing through the air supply flow path 35, thereby adjusting the humidity of the electrolyte membrane 22 in each power generation cell 21 of the FC stack 2.

The hydrogen gas after the reaction in the anode electrode 23 of each power generation cell 21 is discharged as off gas (partially consumed fuel gas) from the hydrogen gas outlet 2d to the off-gas flow path 48. The discharged off gas is introduced from the off-gas flow path 48 into the gas-liquid separator 44 to separate liquid moisture, and is recirculated via the ejector 43 or is mixed with air and diluted when passing through the purge flow path 49 and then discharged to the outside.

In addition, during the execution of the series of power generation operations described above, the cooling system 8 operates according to the temperature of the FC stack 2 to cool the FC stack 2 under the control of the control device 5.

### <Configuration of Control Device 5>

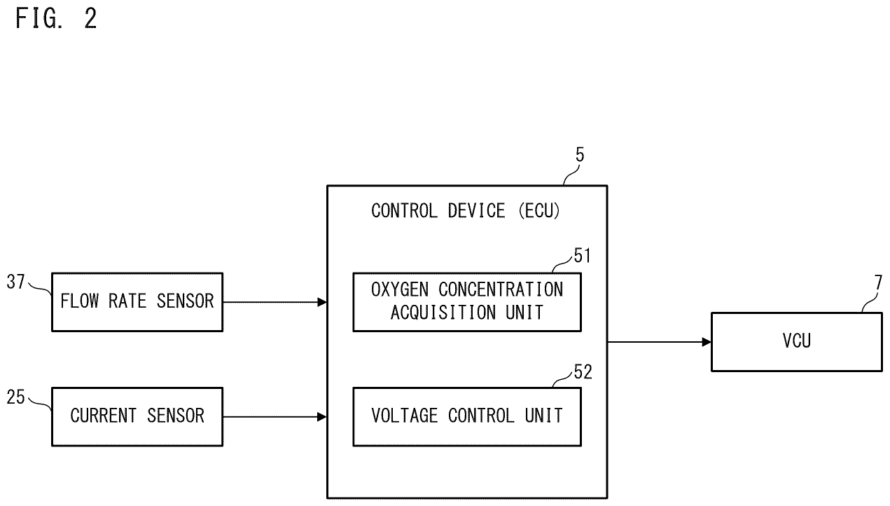

Next, a configuration of the control device 5 will be described. As shown in FIG. 2, in the present embodiment, the control device 5 includes an oxygen concentration acquisition unit 51 and a voltage control unit 52. Each of these functional units is implemented by, for example, a hardware processor, such as the CPU of the control device 5, loading and executing a program (software). Such a program may be stored in the ROM or RAM included in the control device 5, or may be stored in an external storage device (a storage device including a non-transitory storage medium such as an HDD or a flash memory).

In a voltage control process when the FC system 1 is to be stopped, which will be described later, the oxygen concentration acquisition unit 51 estimates an oxygen concentration in the cathode system of the FC stack 2 based on the value of the air flow rate acquired based on the detection value of the flow rate sensor 37 and the value of the generated current of the FC stack 2 acquired from the current sensor 25. In the present embodiment, the amount of air supplied to the cathode electrode 24 of the FC stack 2 is calculated by setting, for the air flow rate at the outlet of the air pump 31 detected by the flow rate sensor 37, an approximate value of a leakage flow rate until the air enters the FC stack 2 and subtracting the approximate value from the air flow rate detected by the flow rate sensor 37.

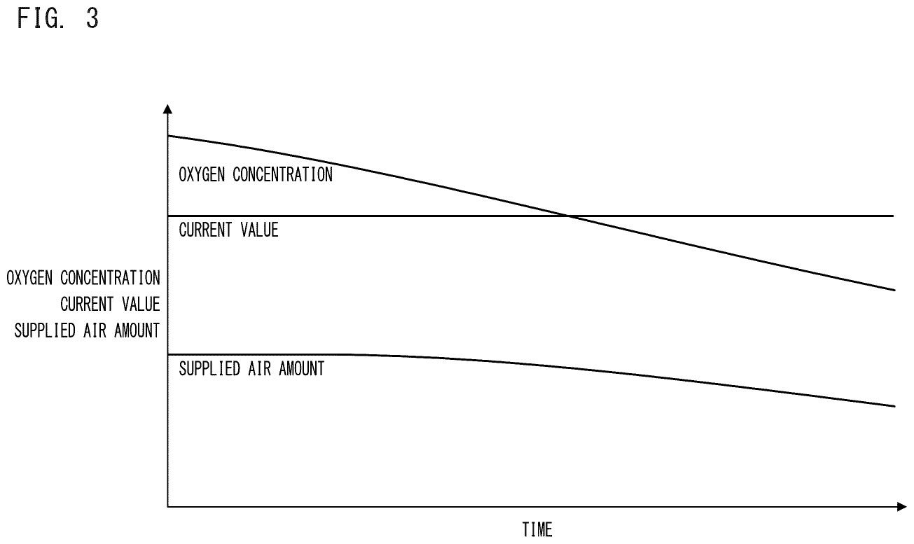

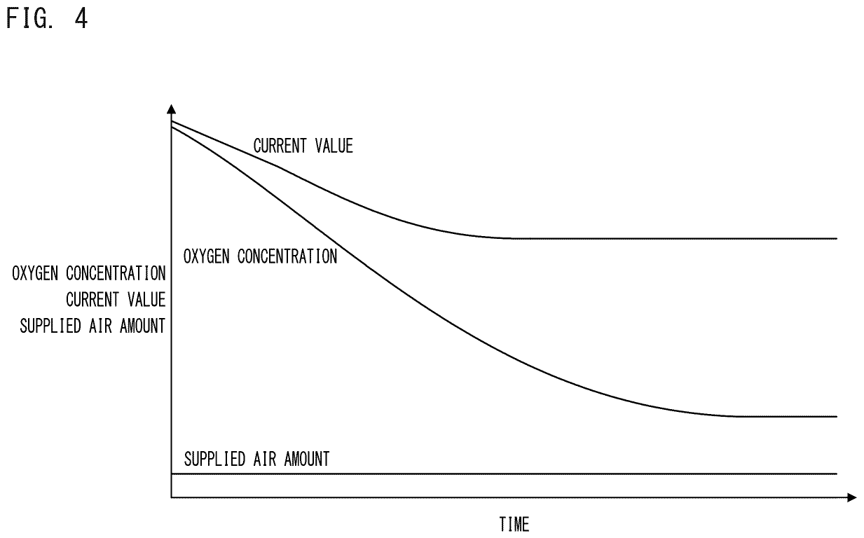

Here, a relationship between a supplied air amount to the FC stack 2, a current value of the FC stack 2, and an oxygen concentration will be described with reference to FIGS. 3 and 4.

FIG. 3 is a diagram showing a relationship between the supplied air amount and the oxygen concentration in the FC stack 2 in a case where the current value is controlled to be substantially constant. As shown in the diagram, it can be seen that when the supplied air amount is gradually reduced while the current value is kept substantially constant, the oxygen concentration decreases so as to follow the reduction. Such a correlation is affected by the degree of oxygen consumption in the FC stack 2, that is, the progress of the reaction between oxygen and fuel gas, but it can be seen that, in general, the oxygen concentration in the FC stack 2 tends to be higher as the supplied air amount is larger, and the oxygen concentration in the FC stack 2 tends to be lower as the supplied air amount is smaller.

Next, FIG. 4 is a diagram showing a relationship between the oxygen concentration and the current value in the FC stack 2 in a case where the supplied air amount is controlled to be substantially constant. As shown in the diagram, it can be seen that when the oxygen concentration decreases due to oxygen being consumed by the reaction between oxygen and fuel gas in the FC stack 2 while the supplied air amount is kept substantially constant, the value of the generated current of the FC stack 2 also decreases so as to follow the decrease. Such a correlation is affected by the degree of oxygen consumption in the FC stack 2, that is, the progress of the reaction between oxygen and fuel gas, but it can be seen that, in general, the oxygen concentration tends to be higher when the detected current value is larger, and the oxygen concentration tends to be lower when the current value is smaller.

The oxygen concentration acquisition unit 51 of the present embodiment uses an estimation logic (relational expression) constructed based on the relationship between the supplied air amount, the current value, and the oxygen concentration to estimate and acquire the current oxygen concentration from the acquired air flow rate and current value.

Note that, in the present embodiment, the oxygen concentration acquisition unit 51 acquires the oxygen concentration by estimation. However, in a case where a device or a machine capable of directly measuring the oxygen concentration in the FC stack 2 can be prepared, the oxygen concentration may be acquired by measurement.

The voltage control unit 52 determines a voltage reduction rate of the FC stack 2 based on the oxygen concentration in the FC stack 2 acquired by the oxygen concentration acquisition unit 51 in the voltage control process when the FC system 1 is to be stopped, which will be described later. Here, the voltage reduction rate of the FC stack 2 means a voltage change rate when the voltage of the FC stack 2 is to be reduced. That is, the voltage is reduced rapidly as the voltage reduction rate is higher, and the voltage is reduced gently as the voltage reduction rate is lower.

In the present embodiment, the oxygen concentration in the FC stack 2 after the start of a process to stop the FC system 1 is used as an index indicating the generated power amount in the FC system 1 after the stop. For example, it is assumed that the generated power amount in the FC stack 2 is large when the oxygen concentration in the FC stack 2 is high. Therefore, it is determined that when the current is increased by reducing the voltage of the FC stack 2, the output (generated power amount) of the FC stack 2 becomes excessive and the upper limit of the power that can be received by the battery 300 is likely to be exceeded. On the other hand, it is assumed that the generated power amount in the FC stack 2 is small when the oxygen concentration in the FC stack 2 is low. Therefore, it is determined that even when the current is increased by reducing the voltage of the FC stack 2, the risk of the generated power of the FC stack 2 exceeding the upper limit of power received by the battery 300 is small.

The determination of the voltage reduction rate based on the oxygen concentration can be performed by, for example, storing a data table defining an optimum voltage reduction rate for each oxygen concentration in advance in a storage unit (not shown) and causing the voltage control unit 52 to refer to the data table. The optimum voltage reduction rate can be set as high as possible within a range without the risk of the generated power amount of the FC stack 2 exceeding the upper limit of power received by the battery 300, for example. The optimum voltage reduction rate for each oxygen concentration can be set based on the results of experiments and simulations performed in advance. By determining the voltage reduction rate in this manner, it is possible to suppress deterioration of the FC stack 2 by reducing the voltage as quickly as possible while preventing the generated power amount of the FC stack 2 from exceeding a predetermined value (for example, an upper limit of power that can be allowed by the battery 300).

Note that when the optimum voltage reduction rate is to be set, the voltage reduction rate may be determined based only on the oxygen concentration, or the voltage reduction rate may be determined after setting, for example, a correction coefficient based on another parameter, such as a voltage value of the FC stack 2, besides the oxygen concentration.

<Voltage Control when FC System 1 is to be Stopped>

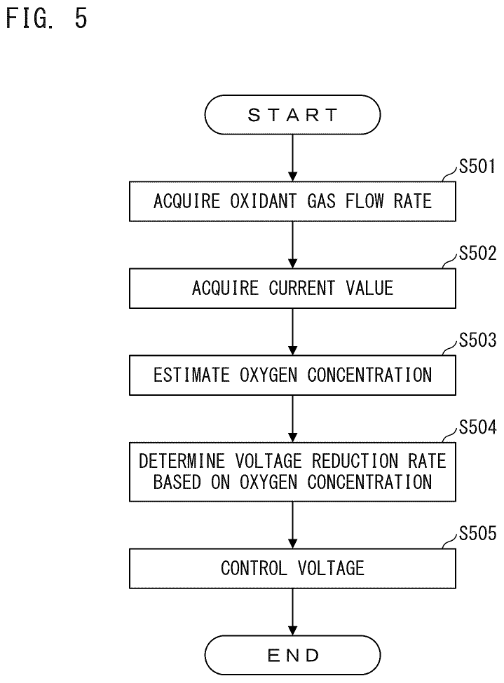

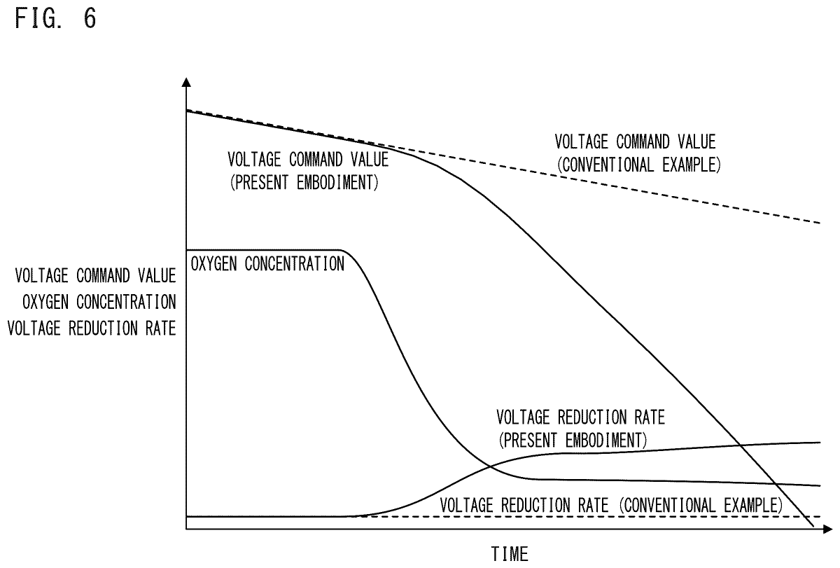

Next, a voltage control when the FC system 1 is to be stopped of the present embodiment will be described with reference to FIGS. 5 and 6. FIG. 5 is a flowchart showing a voltage control process when the FC system 1 is to be stopped. This process is repeatedly performed at a predetermined timing or a predetermined cycle during, for example, a predetermined period of time after the start of a process to stop the power generation operation in the FC system 1 (the power generation operation in the FC stack 2).

Note that the power generation operation in the FC system 1 may be stopped when an ignition switch of the fuel cell vehicle 100 is turned off, or may be automatically stopped according to the charge state of the battery 300 or the driving state of the fuel cell vehicle 100.

In this control process, first, the oxygen concentration acquisition unit 51 of the control device 5 calculates and acquires an air flow rate (oxidant gas flow rate) as an index indicating the supplied air amount in the FC stack 2 based on the current detection value of the flow rate sensor 37 and the approximate value of the leakage flow rate described above (step 501 (shown as “S501”, and the same applies hereinafter)).

Next, the oxygen concentration acquisition unit 51 acquires the value of the generated current of the FC stack 2 based on the current detection value of the current sensor 25 (step 502).

Note that the order of acquisition of the air flow rate (step 501) and the current value (step 502) may be reversed, or the acquisition may be performed simultaneously.

After acquiring the air flow rate and the current value, the oxygen concentration acquisition unit 51 calls the estimation logic constructed in advance, and uses the estimation logic to estimate the current oxygen concentration in the FC stack 2 from the acquired air flow rate and current value (step 503).

After the oxygen concentration acquisition unit 51 estimates the oxygen concentration, the voltage control unit 52 of the control device 5 determines the voltage reduction rate of the FC stack 2 based on the estimated oxygen concentration (step 504). As described above, this determination is performed by reading the data table created in advance and searching for the voltage reduction rate associated with the estimated oxygen concentration. Note that, instead of reading the data table created in advance, the voltage reduction rate can be derived by storing a relational expression between the oxygen concentration and the voltage reduction rate in advance in the storage unit and performing a calculation using this relational expression with respect to the acquired oxygen concentration.

After determining the voltage reduction rate, the voltage control unit 52 sets a value obtained by, for example, multiplying the immediately preceding voltage command value by the determined voltage reduction rate as a new voltage command value. Then, the VCU 7 is controlled in such a manner that the voltage of the FC stack 2 matches the voltage command value (step 505), and this process is terminated.

FIG. 6 is a diagram showing a relationship between the oxygen concentration and the voltage reduction rate in the voltage control during a stop of the present embodiment in comparison with a conventional example.

As described above, conventionally, when the FC system is to be stopped, the voltage of the FC stack has been controlled to be reduced using a constant voltage reduction rate. Therefore, as indicated by the broken lines in FIG. 6, the voltage reduction rate is constant regardless of the oxygen concentration in the FC stack, and the voltage command value decreases linearly according to the constant reduction rate.

On the other hand, in the voltage control of the present embodiment, the voltage reduction rate is changed according to the oxygen concentration in the FC stack. That is, the voltage reduction rate is set in such a manner that the voltage reduction rate is to be low as the oxygen concentration is higher, and the voltage reduction rate is to be high as the oxygen concentration is lower. As a result, it is possible to suppress degradation of the FC stack while controlling the output (generated power amount) of the FC stack is controlled to a certain value or less.

### Effects of Present Embodiment

Hereinafter, effects of the present embodiment will be described.

In the FC system 1 of the present embodiment, the oxygen concentration acquisition unit 51 acquires the oxygen concentration in the FC stack 2, and the voltage control unit 52 changes the voltage reduction rate of the FC stack 2 when the FC system 1 is to be stopped according to the acquired oxygen concentration.

That is, in the FC system 1, the oxygen concentration in the FC stack 2 after the stop of the FC system 1 is used as an index indicating the generated power amount after the stop of the FC system 1, and it is determined that the generated power amount is large and the output of the FC stack 2 is likely to be excessive when the oxygen concentration is high, for example. On the other hand, it is determined that the generated power amount is small and the risk of the output of the FC stack 2 being excessive is small when the oxygen concentration in the FC stack 2 is low. Then, instead of using a fixed voltage reduction rate as in the conventional case, different voltage reduction rates can be used according to the state of power generation of the FC stack 2.

As a result, it is possible, for example, to set the voltage reduction rate low in order to suppress an increase in output when the oxygen concentration is high, and to set the voltage reduction rate high in order to suppress deterioration of the FC stack 2 when the oxygen concentration is low.

In this manner, by changing the reduction rate of the voltage of the FC stack 2 according to the oxygen concentration when an operation of the FC system 1 is to be stopped, it is possible to control the output of the FC stack 2 to a certain value or less while suppressing deterioration of the FC stack 2.

In addition, the oxygen concentration acquisition unit 51 estimates the oxygen concentration based on the flow rate of the oxidant gas (air) supplied to the FC stack 2 and the value of the generated current of the FC stack 2.

That is, in the FC system 1, the air flow rate calculated based on the detection value of the flow rate sensor 37 is used as an index indicating the amount of air supplied to the FC stack 2, and the value of the generated current of the FC stack is used as an index indicating the amount of oxygen consumed in the FC stack 2. Since the oxygen concentration is estimated based on these two indexes, the concentration of residual oxygen in the FC stack 2 can be estimated with high accuracy.

In addition, when the FC system 1 is to be stopped, the voltage control unit 52 performs a control in such a manner as to reduce the voltage reduction rate of the FC stack 2 as the oxygen concentration in the FC stack 2 is higher, and to increase the voltage reduction rate of the FC stack 2 as the oxygen concentration in the FC stack 2 is lower.

Therefore, it is possible to set the voltage reduction rate low in a case where the output is likely to be excessive when there is a large amount of residual oxygen in the FC stack 2, such as immediately after the FC system 1 is stopped, and the generated power amount of the FC stack 2 is large. As a result, it is possible to prevent the output from greatly increasing due to the voltage of the FC stack 2 greatly decreasing to more reliably control the output of the FC stack 2 to a certain value or less.

In addition, it is possible to set the voltage reduction rate high in a case where the generated power amount of the FC stack 2 is small and the risk of the output being excessive is small when a certain time elapses after the stop of the FC system 1 and the oxygen concentration is reduced by oxygen in the FC stack 2 being consumed by reaction with hydrogen. As a result, it is possible to quickly reduce the voltage of the FC stack 2 in a case where there is no risk of the output of the FC stack 2 being excessive to more effectively suppress deterioration of the FC stack 2 by.

Note that the present invention is not limited to the described embodiment, and can be implemented in various modes. In addition, the detailed configuration can be changed as appropriate within the scope of the gist of the present invention.

What is claimed is:

1. A fuel cell system comprising:
a fuel cell stack configured to generate power by reaction between fuel gas and oxidant gas;
an oxidant gas supply device configured to supply the oxidant gas to the fuel cell stack;
an oxygen concentration acquisition unit configured to acquire an oxygen concentration in the fuel cell stack; and
a voltage control unit configured to control a voltage of the fuel cell stack, wherein
the voltage control unit is configured to change a reduction rate of the voltage of the fuel cell stack according to the oxygen concentration when the fuel cell system is to be stopped.

2. The fuel cell system according to claim 1, further comprising:
a flow rate acquisition unit configured to acquire a flow rate of the oxidant gas supplied to the fuel cell stack as an oxidant gas flow rate; and
a current value acquisition unit configured to acquire a current value of the fuel cell stack, wherein
the oxygen concentration acquisition unit is configured to estimate and acquire the oxygen concentration based on the oxidant gas flow rate and the current value.

3. The fuel cell system according to claim 1, wherein the voltage control unit is configured to reduce the reduction rate of the voltage as the oxygen concentration is higher when the fuel cell system is to be stopped.

4. The fuel cell system according to claim 1, wherein the voltage control unit is configured to increase the reduction rate of the voltage as the oxygen concentration is lower when the fuel cell system is to be stopped.

5. A control method of a fuel cell system, the fuel cell system comprising:
a fuel cell stack configured to generate power by reaction between fuel gas and oxidant gas;
an oxidant gas supply unit configured to supply the oxidant gas to the fuel cell stack;
an oxygen concentration acquisition unit configured to acquire an oxygen concentration in the fuel cell stack; and
a voltage control unit configured to control a voltage of the fuel cell stack, wherein
the voltage control unit is configured to perform a control to change a reduction rate of the voltage of the fuel cell stack according to the oxygen concentration when the fuel cell system is to be stopped.
